(19) United States
(12) Patent Application Publication
(10) Pub. No.: US 2008/0187651 A1
(43) Pub. Date: Aug. 7, 2008

(54) CONDUCTIVE INK FORMULATIONS

(75) Inventors: Tzu-Chen Lee, Woodbury, MN (US); Brian K. Nelson, Shoreview, MN (US); Christopher P. Gerlach, Petaluma, CA (US); Dennis E. Vogel, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/552,410

(22) Filed: Oct. 24, 2006

(51) Int. Cl. H01B 1/12; B05D 5/12

(52) U.S. Cl. 427/77; 252/521.6; 252/520.3; 252/521.2

(57) ABSTRACT

Conductive ink formulations comprising a conductive polymer, metallic nanoparticles and a carrier are described. The formulations are printable on a surface, and annealed to form source and drain electrodes.

### FIELD

The present invention relates to conductive ink formulations.

### BACKGROUND

Organic electronics have become more prevalent with the commercialization of organic light emitting diodes (OLED)s and the advancements of organic field effect transistors (OFET)s. The OFETs have lower cost, and provide for larger size capability over inorganic counterparts. For example, silicon or other inorganic based OFETs use traditional fabrication processes which included vacuum-deposition of films, photolithographic and etching processes for pattern formation. In order to achieve lower cost, and large size fabrication capability for OFETs, solution based processes have been developed. Solution coating techniques such as spin coating, dip coating, blade coating, and Mayer bar coating have been used for film formation. In order to form more precise device patterns, ink jet printing, and laser induced thermal imaging techniques have been applied. Ink jet printing of layered patterns is commonly used to simplify device fabrication in electronic applications.

Ink jet printing for patterning of layers of electronic devices requires that components are in liquid form. Further, specific rheological properties are required for printing the conductor, semiconductor and dielectric layers. Developments of these layers have been further described in U.S. Pat. No. 6,586,791 (Lee et al.) and U.S. Pat. No. 5,777,070 (Inbasekaran et al.); Klauk, H. et al., J. Appl. Phys., 92, pp. 5259-5263 (2002); Park, J. et al., SID 05 Digest, P-4, pp. 236-239; Sirringhaus, H. et al., Science, 290, pp. 2123-2126 (2000); Beng, S. et al., JACS, 126, pp. 3378-3379 (2004); Hong, C. M. et al., IEEE Electron Device Letters, 21, pp. 384-386 (2000); Brust, M. et al., J. Chem. Soc. Chem. Commun., pp. 801-2 (1994); and U.S. Pat. Publ. No. 2006/01249922A1 (Kim et al.).

Ink jet imaging techniques are known in commercial and consumer applications. Ink jet printers operate by precisely ejecting very small drops of fluid (e.g. ink) onto a receiving substrate in controlled patterns of closely spaced ink droplets. Inks used in inkjet printing are typically free of particulates greater than 500 nm in size, and more typically free of particulates greater than 200 nm in size, where the ink further requires suitable rheological properties. By selectively regulating the pattern of ink droplets, ink jet printers can produce a wide variety of printed features, including text, graphics, images, holograms, and the like. Moreover, inkjet printers are capable of forming printed features on a wide variety of substrates, including not just flat films or sheets, but also three-dimensional objects as well.

Thermal ink jet printers and piezo ink jet printers are the two main types of ink jet systems in widespread use. With both approaches, the jetted fluid must meet stringent performance requirements in order for the fluid to be appropriately jettable and for the resultant printed features to have the desired electrical, mechanical, chemical, visual, and durability characteristics.

### SUMMARY

The present disclosure is directed to ink formulations printable as source and/or drain electrodes for electronic devices. An ink formulation comprises at least one conductive polymer, metallic nanoparticles, and a carrier. The metallic nanoparticles are dispersed within the conductive polymer, where the weight ratio of the conductive polymer to the metallic nanoparticles ranges from 1:3 to 1:1. The carrier is a solvent for the conductive polymer.

In one aspect, the conductive polymer comprises a dopant such as sorbitol or glycerol to enhance the conductivity of the source and drain electrodes in an electronic device.

In one aspect, the ink formulations may include a conductive polymer such as poly(3,4-ethylenedioxythiophene)/poly(styrene sulfonate), and sorbitol as a dopant.

In one aspect, the metallic nanoparticles have an average particle size less than 500 nm. In another aspect, the metallic nanoparticles have an average particle size less than 100 nm. The metallic nanoparticles comprise silver, aluminum, copper, nickel, and combinations thereof.

The present disclosure is further directed to a method for forming an electrode by applying an ink formulation to a surface of a substrate, and annealing the applied formulation in a one step process. The formulation may be applied by ink jet printing, screen printing, gravure printing, flexographic printing, contact printing, or spraying. The applied formulation may be annealed from 100° C. to 175° C.

The present disclosure is further directed to an ink formulation comprising at least one conductive polymer, metallic nanoparticles, and a carrier. The formulation, when annealed, forms source and drain electrodes of an electronic device, where a semiconductor layer may be disposed. A device using these source and drain electrodes of this disclosure has a greater mobility than a device comprising metallic nanoparticles alone as source and drain electrodes.

The present disclosure is further directed to a transistor. The source and drain electrodes disposed on a substrate of the transistor may be further coated with a semiconductor layer, such as 6,13-bis[(tri-isopropylsilanyl)ethynyl)]pentacene. An electronic device may further comprise a multiplicity of transistors.

Silver nanoparticle inks, as metallic nanoparticles, have been previously used for forming source and drain electrodes of organic field effect transistors. However, silver nanoparticle inks have poor performance due to a poor energy lineup at the interface of the metal and organic semiconductor. Further, semiconductive films may dewet or delaminate from the silver nanoparticle ink electrodes.

Conducting polymers, such as polyaniline or poly(3,4-ethylenedioxythiophene)/poly(styrene sulfonate) (PEDOT/PSS) can be used as conducting electrodes in organic light emitting diodes, photovoltaic cells and organic field effect transistors. PEDOT/PSS has a better matched work function with organic semiconductors compared to silver nanoparticle inks, but lower conductivity than metal electrodes.

Source and drain electrodes can be made by a two step process comprised of first coating the source and drain electrodes with silver nanoparticle ink, and in a second step, coating the conductive polymer on the nanoparticle ink. However, cost and the added processing time of using a two step printing process may not be desirable.

In this disclosure, an ink formulation is described. The formulation is printed onto a substrate in a one step process, and annealed. A semiconductor layer is subsequently coated over the source and drain electrodes. The device of the ink formulation has greater mobility than a device comprising silver nanoparticles without a conductive polymer.

### DETAILED DESCRIPTION

For the following defined terms, these definitions shall be applied, unless a different definition is given in the claims or elsewhere in the specification.

The term “mobility” means a low electric field, where the drift velocity of the carriers, v_{d}, in a semiconductor is proportional to the electric field strength, E. The proportionality constant is defined as the mobility, μ, in cm²/V·s, and v_{d}=μE; as referenced in Sze, S. M., Physics of Semiconductor Devices, 2^{nd} Ed. John Wiley and Sons, Inc. (1981).

The term “volume resistivity” means a value of electrical resistance expressed in a unit volume (1 cm×1 cm×1 cm), as ρᵥ (ohm-cm). This value is usually obtained by measuring the potential difference (V) between two electrodes separated in a distance (L) when a constant current (I) flows through a cross-sectional area (A); where ρᵥ=(V/I)(A/L) as referenced in Loresta-G P, Instruction Manual for Low Resistivity Meter (Mitsubishi Chemical Corporation).

The term “conductivity” is the reciprocal of the volume resistivity, ρᵥ, where conductivity is referred to as σ (Siemen/cm or S/cm).

The term “source and drain electrode” of a field effect transistor (U.S. Pat. No. 1,745,175 (Lilienfeld)), is a component of a transistor, operating as a capacitor with one plate serving as a conducting channel between two ohmic contacts, i.e. source and drain electrodes. The gate controls the charge induced into the channel, where the carriers in the channel come from the source electrode and move across the channel into the drain electrode, as described in Shur, M., Physics of Semiconductor Devices, Prentice Hall, p. 328, (1990).

The recitation of numerical ranges by endpoints includes all numbers subsumed within that range (e.g., 1 to 5 includes 1, 1.5, 2, 2.75, 3, 3.80, 4, and 5).

As included in this specification and the appended claims, the singular forms “a”, “an”, and “the” include plural referents unless the content clearly dictates otherwise. Thus, for example, reference to a composition containing “a compound” includes a mixture of two or more compounds. As used in this specification and appended claims, the term “or” is generally employed in its sense including “and/or” unless the content clearly dictates otherwise.

Unless otherwise indicated, all numbers expressing quantities or ingredients, measurement of properties and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present disclosure. At the very least, and not as an attempt to limit the application of the doctrine of equivalents to the scope of the claims, each numerical parameter should at least be construed in light of the number of reported significant digits and by applying ordinary rounding techniques. Not withstanding that the numerical ranges and parameters setting forth the broad scope of the disclosure are approximations, their numerical values set forth in the specific examples are reported as precisely as possible. Any numerical value, however, inherently contains errors necessarily resulting from the standard deviations found in their respective testing measurement.

The ink formulations of this disclosure comprise at least one conductive polymer, metallic nanoparticles, and a carrier. The metallic nanoparticles are dispersed within the conductive polymer at a weight ratio of conductive polymer to metallic nanoparticles of from 1:3 to 1:1. The formulation may further comprise a dopant selected from glycerol or sorbitol.

Conductive polymers are understood as substances which are built up of small molecule compounds, are at least oligomeric by polymerization, and thus contain at least 3 monomer units which are linked by chemical bonding, display a conjugated π-electron system in the neutral (nonconductive) state, and can be converted by oxidation, reduction or protonation (e.g. doping) into an ionic form which is conductive. The conductivity is at least 10⁻⁷ S/cm and is normally less than 10⁵ S/cm.

Conductive polymers can be chemically diverse in composition. In particular, conductive polymers include poly(3,4-ethylenedioxy thiophene) (PEDOT), polyaniline (PAni), polypyrrole (PPy), polythiophene (PT), polydiacetylene, polyacetylene (PAc), polyisothianaphthene (PITN), polyheteroarylene-vinylene (PArV), wherein the heteroarylene group can for example be thiophene, furan or pyrrole, poly-p-phenylene (PpP), polyphenylene sulphide (PPS), polyperinaphthalene (PPN), polyphthalocyanine (PPc) and derivatives thereof, copolymers thereof, and physical mixtures thereof. Preferable conductive polymers include poly(3,4-ethylenedioxythiophene), polyaniline, polypyrrole, and combinations thereof.

Dopants or doping agents for conductive polymers include iodine, peroxides, Lewis acids and protic acids for doping by oxidation; and sodium, potassium, and calcium for doping by reduction.

In one aspect, poly(styrene sulfonate) (PSS) is selected as a dopant.

In one aspect, the ink formulation further comprises Lewis acid dopants selected from sorbitol and glycerol, or combinations thereof.

In another aspect, these dopants may interact with PEDOT/PSS, for example, causing a separation of the polymeric chains. During the annealing process, the dopant evaporates, which may create separation of the chains generating more freedom for rearrangement, thus forming a more favorable state that results in bringing them closer to each other as described in the mechanism proposed by Timpamaro, S. et al., Chem. Phys. Letters, 394, pp. 339-343 (2004). Higher conductivity of PEDOT/PSS doped with sorbitol is observed as compared to PEDOT/PSS without the dopant.

In an exemplary embodiment, the conductive polymer is poly(3,4-ethylenedioxythiophene)/poly(styrene sulfonate) and the dopant is sorbitol.

Metallic nanoparticles of the ink formulation disclosed are dispersed in the conductive polymer of the disclosure. Nanoparticles include gold, silver, aluminum, platinum, palladium, copper, nickel, and derivatives and combinations thereof, preferably nanoparticles comprising silver, aluminum, copper, nickel and combinations thereof, and more preferably nanoparticles comprising silver.

Nanoparticles generally have an average particle size ranging less than about 500 nm. In one aspect, the average particle size is less than 100 nm. In one aspect, the average particle size is less than 50 nm. The particles are substantially non-agglomerated, where the nanoparticles may be optionally surface treated. Surface treatments may be used to prevent clumping and clustering of the nanoparticles, aiding in stability of the ink formulation and subsequent deposition onto the surface of a substrate. In this disclosure, the commercially available nanoparticles are preferably surface treated from commercial sources described in the Examples section.

The metallic nanoparticles are dispersed within the conductive polymer, where a carrier mixes the conductive polymer and the metallic nanoparticles. The ratio of conductive polymer to metallic nanoparticles may range from 1:3 to 1:1 on a weight basis to form a stable dispersion in a carrier. More preferably, the ratio of conductive polymer to metallic nanoparticles may range from 1:2 to 1:1 on a weight basis. The stability of the conductive polymer to metallic nanoparticles at a particular concentration in a carrier is important for subsequent application. The nanoparticles and the conductive polymer may be diluted from their initial (as received) concentrations to provide a stable mixture and/or dispersion. Combining metallic nanoparticles and conductive polymers at higher concentrations may lead to high viscosities, unstable dispersion/mixtures, and inconsistent printing applications. Higher viscosity formulations may result in the inability to inkjet print such formulations.

At conductive polymer to metallic nanoparticle ratios of 1:12 to 1:85, mobility of the device comprising the ink formulation decreases. However, the mixtures may be unstable creating particle settling and/or agglomerates, making printing difficult. The agglomerates or settled particles may be filtered from the carrier, but the ratio of conductive polymer to metallic nanoparticles may have changed relative to the initial charge. The volume resistivity of films at ratios of conductive polymer to metallic nanoparticles greater than 1:3 (e.g., 1:12 to 1:85) may yield unstable ink formulations, particle agglomeration, particle settling, and surface roughness of cast films.

The carrier of the ink formulation functions to mix the conductive polymer and metallic nanoparticles, where the carrier is a solvent the conductive polymer. The conductive polymer may dissolve in the carrier. Further, the metallic nanoparticles may be dispersed in the conductive polymer.

The carrier of the ink formulation may include one or more carriers. The carrier may be present in an amount sufficient to disperse the metallic nanoparticles and dissolve the conductive polymer, plus adjust the viscosity of the ink formulation suitable for a chosen application. Carriers may include water, organic solvents (e.g. mono-, di-, or tri-ethylene glycols or higher ethylene glycols, propylene glycol, 1,4-butanediol or ethers of such glycols, thiodiglycol, glycerol and ethers and esters thereof, polyglycerol, mono-, di-, and tri-ethanolamine, propanolamine, N,N-dimethylformamide, dimethyl sulfoxide, dimethylacetamide, N-methylpyrrolidone, 1,3-dimethylimidazolidone, methanol, ethanol, isopropanol, n-propanol, diacetone alcohol, acetone, methyl ethyl ketone, propylene carbonate), and combinations thereof.

For example, with an ink jet printing method, the formulation may be adjusted by the addition of a carrier to a viscosity of less or equal to 40 millipascal-seconds, and more preferably 20 millipascal-seconds at operational temperatures. Surface tension of the ink formulation may range from 25 to 35 dynes/cm.

The surface for applying the ink formulation can be any solid substrate. Useful surfaces on a substrate may comprise ceramic, glass, metal, or combinations thereof. Further, the surface of the substrate to receive the ink formulation may include at least one organic polymer such as polyethylene, polypropylene, polyimide, polyester, polyethylene naphthalate (PEN), polyethylene terephthalate (PET) or combinations thereof. The substrate may be coated with a receptor coating. Useful surfaces of substrates may include flexible substrates and rigid substrates, and other substrates. Preferably, ceramic, silica, glass substrates, and polymeric substrates are useful for receiving of printed source and drain electrodes for electronic devices, such as transistors, of the disclosure.

Traditional printing methods for applying the ink formulation of this disclosure include inkjet printing, screen printing, gravure printing, flexographic printing, contact printing, nano-imprinting, or spraying as referenced in Kirk-Othmer Encyclopedia of Chemical Technology 4^{th} Edition, vol. 20, John Wiley and Sons, New York, pages 112-117. Combinations of these methods may be contemplated for applying the ink formulations.

Ink formulations for printing require certain properties to be printed or coated. For example, the formulation must have a viscosity making it amenable to inkjet print onto the surface of a substrate. Typically, an ink formulation has a viscosity of 1 to 40 millipascal-seconds at the print head temperature, measured using a continuous sweep over shear rates of 1 second⁻¹ to 1000 second⁻¹; and frequently a viscosity of 10 to 14 millipascal-seconds measured using a continuous stress sweep, over shear rates of 1 second⁻¹ to 1000 second⁻¹.

In the present disclosure, a method of forming an electrode(s) comprising the ink formulation is described. Formulations of this disclosure are capable of being printed and annealed to form an electrode(s) of an electronic device. The formulations are printable using digital printing methods, including inkjet printing.

In one aspect, the ink formulation is ink jet printed onto a substrate. Exemplary inkjet printing methods include thermal inkjet, continuous inkjet, piezo inkjet, acoustic inkjet, and hot melt inkjet printing. Thermal inkjet printers and/or print heads are readily commercially available, for example, from Hewlett-Packard Company (Palo Alto, Calif.), and Lexmark International (Lexington, Ky.). Continuous inkjet print heads are commercially available, for example, from continuous printer manufacturers such as Domino Printing Sciences (Cambridge, United Kingdom). Piezo inkjet print heads are commercially available, for example, from Trident International (Brookfield, Conn.), Epson (Torrance, Calif.), Hitachi Data systems Corporation (Santa Clara, Calif.), Xaar PLC (Cambridge, United Kingdom), Fujifilm Dimatix (Lebanon, N.H.), and Idanit Technologies, Limited (Rishon Le Zion, Isreal). Hot melt inkjet printers are commercially available, for example, from Xerox Corporation (Stamford, Conn.).

In another aspect, inkjet printing is highly versatile in that printing patterns can be easily changed, whereas screen printing and other tool-based techniques require a different screen or tool to be used with each individual pattern. Inkjet printing does not require a large inventory of screens or tools that need to be cleaned and maintained.

The ink formulation may contain one or more optional additives such as, for example, colorants (e.g. dyes and/or pigments), surfactants, thixotropes, thickeners, or a combination thereof.

The printed ink formulation may be further annealed to remove the carrier and further agglomerate the metallic nanoparticles. The ink formulation may be annealed at a temperature ranging from 100° C. to 175° C. for 0.1 to 24 hours in an inert atmosphere. Annealing times of 0.1 to 1 hour are preferred. The ink formulations, more preferably, are annealed at 125° C. to 150° C. The formulation will harden or toughen forming conductive source and/or drain electrodes, where the metallic nanoparticles are dispersed within the conductive polymer.

In one aspect, the printed formulation forms electrodes of a device, such as in an organic field-effect transistor (OFET). The mobility of the device comprising source and drain electrodes, a gate electrode, a gate insulator, and a semiconductor layer can be measured. Mobility defines the transport of free charge carriers in semiconductors. The mobility of a device comprising the annealed ink formulation of a conductive polymer and metallic nanoparticles is greater than an annealed ink formulation in a device containing only metallic nanoparticles. Further, the annealed ink formulation may be doped with sorbitol or glycerol.

In one aspect, an organic electronic device comprises source and drain electrodes of the annealed ink formulation. An electronic device may further comprise a multiplicity, or more than one set of source and drain electrodes.

A transistor may comprise source and drain electrodes of at least one conductive polymer and metallic nanoparticles dispersed within the conductive polymer, where the weight ratio of conductive polymer to metallic nanoparticles ranges from 1:3 to 1:1. The transistor may further include a dopant selected from glycerol and sorbitol. A semiconductor layer, such as 6,13-bis[(triisopropylsilanyl)ethynyl]pentacene may be disposed on the surface of the electrodes. An electronic device may comprise a multiplicity of transistors comprising a conductive polymer and metallic nanoparticles.

The formulations may be used in a wide variety of electronic devices. Examples include sensors, touch screens, diodes, capacitors (e.g. embedded capacitors), resistors, and photovoltaic cells, which can be used in various arrays to form amplifiers, receivers, transmitters, inverters, oscillators, and power devices.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents, carriers, and other reagents used were obtained from Sigma-Aldrich Chemical Company; Milwaukee, Wis. unless otherwise noted.

Table of Abbreviations

| Abbreviation | |
|---|---|
| or Trade | |
| Designation | Description |
| PEDOT-PSS | Poly(3,4-ethylenedioxythiophene)-Poly(styrenesulfonate) |
| | commercially available from Sigma-Aldrich Chemical Company, |
| | Milwaukee, WI, as a 1.3 weight % aqueous solution. |
| PAni | Polyaniline D1005W, commercially available from Ormecon, |
| | Ammersbek, Germany, as a 4 weight % aqueous solution. |
| Polypyrrole | Polypyrrole commercially available from Sigma-Aldrich Chemical |
| | Company, Milwaukee, WI, as a 5 weight % aqueous solution. |
| Sorbitol | Commercially available from Avocado Research Chemicals Ltd.; |
| | Lancaster, UK. |
| TIPS pentacene | TIPS-pentacene: (6,13-bis(triisopropylsilanyl)ethynyl)pentacene was |
| | synthesized as described in U.S. Pat. No. 6,690,029 B1. |
| Silver Ink-1 | Silver nanoparticle ink (metallic nanoparticles) commercially available |
| | from Cabot Corp.; Albuquerque, NM, as a 20 weight % solids metal |
| | nanoparticles (30–50 nm diameter) in a mixture of ethanol and |
| | ethylene glycol with a viscosity of 14.4 mPa-sec. |
| Silver Ink-2 | SVE 102 Silver nanoparticle ink (metallic nanoparticles) commercially |
| | available from Nippon Paint (America) Corp.; Teaneck, NJ, as a 30 |
| | weight % solids metal nanoparticles (30 nm diameter) in ethanol with a |
| | viscosity of 2 mPa-sec. |
| Silver Ink-3 | NP1050 Silver nanoparticle ink (metallic nanoparticles) commercially |
| | available from Nippon Paint (America) Corp.; Teaneck, NJ, as a 30 |
| | weight % solids metal nanoparticles (30 nm diameter) in ethanol with a |
| | viscosity of 20 mPa-sec. |
| Silver Ink-4 | A water-based silver ink (metallic nanoparticles) containing 20 weight |
| | % solids metal particles (200 nm diameter) with a viscosity of 1–5 mPa-sec., |
| | commercially available from NovaCentrix Corp.; Austin, |
| | TX. |
| TMN-6 | Tergitol TMN-6, a surfactant commercially available from DOW |
| | Chemical; Midland, Michigan. |

### Test Methods

### Preparation of a Test Device

Test devices were prepared and used to characterize the ink formulations. A clean SiO₂/n⁺-Si/Al substrate was used as a gate electrode and a gate dielectric layer. On top of it, source and drain electrodes were formed by either inkjet printing or painting. Some low temperature annealing at a temperature between 100° C. to 175° C. occurred in air (below 125° C.) or in a nitrogen environment (above 125° C.), followed by spraying toluene to remove any organic residue, and further followed by another short baking at about 100° C. to remove excess toluene. TIPS pentacene was knife-coated on top of the electrodes without further baking. Hewlett-Packard 4145A Semiconductor Parameter Analyzer, equipped with home-written software, was used for the transistor characterization.

### Electrical Measurements and Calculations

The carrier mobility, μ (cm²/V·sec), current ON/OFF ratio, and threshold voltage, Vₜ (i.e., minimum gate voltage required to open the channel and allow drain current to flow) were measured as described below:

From a plot of source-to-drain current, I_{SD}, vs. the gate voltage, V_{g}, the ON/OFF ratio is the ratio of the highest I_{SD} in the saturation region and the lowest I_{SD} before the transistor was turned on.

From a plot of a square root of the source-to-drain current, √I_{SD}, vs. V_{g}, the slope at the saturation region determines the mobility based on the following equation:

√I_{DS}=μ^{1/2}[(Wcᵢ/2L)^{1/2}(V_{g}−Vₜ)],

where W is the channel width, and L is the channel length, and cᵢ is the

specific capacitance resulting from the gate dielectric, and the intersection of the slope with V_{g} determines the threshold voltage, Vₜ.

### Water Contact Angle Measurement

Water contact angles were measured with a video contact angle apparatus (Model VCA-2500XE (AST Products; Billerica, Mass.)). The static contact angle was recorded with a water drop profile from a snap shot taken immediately where a water drop was in contact with the described surface at both edges. Estimated uncertainties in these measurements were ±1 degree.

### ESCA Measurement

The levels of silver (Ag), and PEDOT-PSS on the specimen surfaces of samples were examined using x-ray photoelectron spectroscopy (XPS) or Electron Spectroscopy for Chemical Analysis (ESCA). ESCA is a non-destructive technique which provides an analysis of the outermost 3.0 nm to 10.0 nm of the specimen surface. The photoelectron spectra from ESCA provides information about the elemental and chemical (oxidation state and/or functional group) concentrations present on a solid surface with detection limits for most species in the 0.1 to 1 atomic % concentration range. All ESCA analysis was performed using a 90° Photoelectron Take-Off Angle. The area analyzed was approximately 110-1,000 micrometers in diameter depending on the analysis area dictated by each specimen. An ESCA survey spectrum was recorded on three different areas on each sample surface, and from these, the mean relative surface elemental compositions were calculated. The S(2p_{3/2,1/2}) photoelectron spectra taken on the samples showed the presence of two distinct types of sulfur present, i.e., thio-species (—C—S—C—) and an oxygen-bearing moiety (—SOₓ). Linear least-squares peak-fitting of the S(2p_{3/2,1/2}) photoelectron spectra were measured. Based on the chemical structures for PEDOT (contains —C—S—C—) and PSS (contains —SO₃⁻), the ratio of the two types of sulfur provides a relative measure of the amount of these compounds present on the surface of each sample for which sulfur was detected. The summation of these two types of sulfur contributes to the presence of PEDOT-PSS on the surface. Elemental silver was detected independently.

### Surface Resistance Measurement

A four-point probe (Loresta-GP, Mitsubishi Chemical Corporation, Japan) was used for measuring the surface resistance (ohm/sq) of the annealed film. The equipment was equipped with software that can provide a correction factor for the regular shaped samples (e.g., rectangle, circle, etc.) with limited dimensions for achieving more reliable surface resistance. It can measure films with surface resistance values in the range of 10⁻³ ohm/sq to 10⁸ ohm/sq.

### Film Thickness Measurement

An annealed film coated on a clean glass substrate was scraped off by a sharp razor blade to form a narrow trench where at its bottom, the glass substrate surface was exposed. A Veeco Dektak 6M bench-top stylus profiler (Woodbury, NY) was used by scanning a stylus softly tracing across a distance that covers both the coated film and scraped trench. Further, the depth of the trench, and the film thickness can be measured.

### Volume Resistivity Calculation

The volume resistivity (ohm-cm) measurement was determined by multiplying the film thickness measurement (cm) by the surface resistance measurement (ohm/square).

### Comparative Examples C1-C3 and C1′-C3′

Using the Test Device preparation method described above, source and drain electrodes were prepared as follows: Comparative Example C1 (Silver Ink-1) was inkjet printed; Comparative Example C2 (PEDOT-PSS) was painted; and Comparative Example C3 (sorbitol-doped (3 weight %) PEDOT-PSS) was painted. Values for carrier mobility, current ON/OFF ratio, and threshold voltage were measured or calculated as described above, and reported in Table 1. Water Contact Angle measurements were measured independently from the coated films according to the test method described above with the data in Table 2.

Due to possible agglomeration of the silver nanoparticles and the conductive polymers mixed together, the mixtures were diluted resulting in lower solids content in Comparative Examples C1′-C3′. The dilutions were analogous to the Examples of this section.

Undiluted ink formulations C1, C2, and C3 were coated with a No. 6 Mayer bar on a glass substrate, and annealed at 150° C. in a nitrogen atmosphere. The coating thickness was about 0.26 micrometers. Average volume resistivity of C1=2.6×10⁻⁶ ohm-cm, C2=4 ohm-cm, and C3=1.7×10⁻² ohm-cm was recorded.

### Comparative Example C4

Using the Test Device preparation method described above, source and drain electrodes were prepared by printing Silver Ink-1 followed by painting sorbitol-doped (3 weight %) PEDOT-PSS on top of the coated silver, and baking for 3 minutes at 150° C. under a nitrogen atmosphere. Values for carrier mobility, current ON/OFF ratio and threshold voltage were measured or calculated as described above, and reported in Table 1.

### Example 1

An ink formulation containing a mixture of Silver Ink-1 and PEDOT-PSS was prepared with a PEDOT-PSS:Ag ratio (parts by weight, dry weight) of 1:77. The ink formulation was prepared by mixing diluted mixtures of Silver Ink-1 and PEDOT-PSS. The Silver Ink-1 was diluted to 50% of its original concentration by adding a 50:50 weight ratio of carrier (ethylene glycol and ethanol) to the ink. The PEDOT-PSS was diluted to 10% of its original concentration by adding 10 times its weight of deionized water to it. The two diluted solutions were mixed in a 50:50 weight ratio to yield the ink formulation. Using the Test Device preparation method described above, source and drain electrodes were prepared by printing this ink formulation. Values for carrier mobility, current ON/OFF ratio and threshold voltage were measured or calculated as described in the test methods and reported in Table 1. Water Contact Angle measurements were made on different parts of the electrodes, either the whitish (silver-like portion) or less silver-like portion according to the test method given above and reported in Table 2. ESCA Measurements were made as described in the test method above and the Ag:S atom ratio is reported in Table 3.

### Example 2

An ink formulation containing a mixture of Silver Ink-1 and PEDOT-PSS doped with sorbitol (3 weight %) was prepared with a PEDOT-PSS:Ag ratio (parts by weight, dry weight) of 1:11.8. The Silver Ink-1 was diluted to 25% of its original concentration with ethylene glycol and ethanol. The 3 weight % sorbitol doped PEDOT-PSS was diluted to 33% of its original concentration with deionized water. The two diluted solutions were mixed to give an ink formulation. Using the Test Device preparation method described, source and drain electrodes were prepared by printing the ink formulation. Values for carrier mobility, current ON/OFF ratio and threshold voltage were measured or calculated as described, and reported in Table 1. Water Contact Angle measurements were made on different parts of the electrodes, either the whitish (more silver-like portion) or less silver-like portion, and reported in Table 2. ESCA Measurements were made as described, where the Ag:S atom ratio is reported in Table 3.

### Example 3

An ink formulation containing a mixture of Silver Ink-1 and PEDOT-PSS doped with sorbitol (3 weight %) was prepared with a PEDOT-PSS:Ag ratio (parts by weight, dry weight) of 1:2.5. The ink formulation was prepared by mixing diluted mixtures of Silver Ink-1 and PEDOT-PSS as described in Example 2. Using the Test Device preparation method, source and drain electrodes were prepared by printing the ink formulation. Values for carrier mobility, current ON/OFF ratio and threshold voltage were measured or calculated as described in the test methods above and are reported in Table 1. Water Contact Angle measurements were made on different parts of the electrodes, the whitish (more silver-like portion) or the less silver-like portion, and reported in Table 2. ESCA measurements were made as described, and the Ag:S atom ratio is reported in Table 3.

TABLE 1

| | | Current ON/OFF | Threshold Voltage |
|---|---|---|---|
| Example | Mobility (cm²/V · s) | ratio | (Volts) |
| C1 | 4 × 10⁻⁴ | 1 × 10³ | −8 |
| C2 | 1.2 × 10⁻³ | 4.9 × 10³ | −0.49 |
| C3 | 7 × 10⁻³ | 2.4 × 10⁴ | −0.4 |
| C4 | 2.6 × 10⁻⁴ | 1.7 × 10³ | −0.7 |
| 1 | 5.9 × 10⁻⁴ | 4.5 × 10³ | −2.5 |
| 2 | 2.3 × 10⁻³ | 2.9 × 10³ | −6.7 |
| 3 | 2.6 × 10⁻³ | 2.6 × 10³ | −0.34 |

TABLE 2

| Example | Left Contact | Right Contact | |
|---|---|---|---|
| Surface | Angle | Angle | Comments |
| C1 | 21.40 | 23.80 | — |
| C2 | 59.10 | 59.60 | — |
| C3 | 54.10 | 53.30 | — |
| 1 | 37.50 | 37.40 | Less Ag-like |
| 1 | 33.30 | 31.70 | More Ag-like |
| 2 | 45.60 | 46.00 | Less Ag-like |
| 2 | 20.00 | 20.00 | More Ag-like |
| 3 | 40.00 | 39.90 | Less Ag-like |
| 3 | 30.30 | 32.20 | More Ag-like |

### Example 4

An ink formulation containing a mixture of Silver Ink-1 and PEDOT-PSS doped with sorbitol (3 weight %) was prepared with a PEDOT-PSS:Ag ratio (parts by weight, dry weight) of 1:1. The ink formulation was prepared by mixing diluted mixtures of Silver Ink-1 and PEDOT-PSS as described in Example 2. Using the Test Device preparation method, electrode-like patterns were prepared by painting the ink formulation. ESCA Measurements for the Ag:S atom ratio is reported in Table 3.

TABLE 3

| Example | Ag:S Atom Ratio |
|---|---|
| 1 | 2.7 |
| 2 | 2.0 |
| 3 | 1.7 |
| 4 | 0.6 |

### Example 5

An ink formulation containing a mixture of Silver Ink-1 and polypyrrole was prepared with a polypyrrole:Ag ratio (parts by weight, dry weight) of 1:7.4. The ink formulation was prepared by mixing diluted mixtures of Silver Ink-1 and polypyrrole. The Silver Ink-1 was diluted by mixing 1 part by weight of the Silver Ink-1 with 5 parts by weight of carrier (ethylene glycol and ethanol). The polypyrrole solution was made by adding 1 part by weight of polypyrrole and 10 parts by weight deionized water. The two diluted solutions were mixed in a 50:50 weight ratio to give the ink formulation. Using the Test Device preparation method, source and drain electrodes were prepared by painting the ink formulation, and baking at 125° C. for 10 minutes in air. The transistor performance of the test device thus made with these two electrodes was comparable to Comparative Example C1.

### Example 6

An ink formulation containing a mixture of silver ink-1 and PAni was prepared with a PAni:Ag ratio (parts by weight, dry weight) of 1:7.5. The ink formulation was prepared by mixing diluted mixtures of Silver Ink-1 and PAni. The Silver Ink-1 was diluted by mixing 1 part by weight of the Silver Ink-1 with 5 parts by weight of carrier (ethylene glycol and ethanol). The PAni solution was made by adding 1 part by weight of PAni and 8 parts by weight deionized water. The two diluted solutions were mixed in a 50:50 weight ratio to give the ink formulation. Using the Test Device preparation method, source and drain electrodes were prepared by painting this ink formulation and baking at 125° C. for 10 minutes in air. The transistor performance of the test device thus made with these two electrodes was comparable to Comparative Example C1 (Silver Ink-1 alone).

### Example 7

An ink formulation containing a mixture of Silver Ink-2 and PEDOT-PSS doped with sorbitol (3 weight %) was prepared with a PEDOT-PSS:Ag ratio (parts by weight, dry weight) of 1:1. The Silver Ink-2 was diluted by mixing 1 part by weight of the Silver Ink-2 with 3 parts by weight of ethanol. The PEDOT-PSS was diluted by adding 1 part by weight of PEDOT-PSS and 6 parts by weight deionized water. Using the Test Device preparation method, source and drain electrodes were prepared by painting the ink formulation and baking at 125° C. for 10 minutes in air. Transistor performance of the test device thus made with these two electrodes was not observed.

### Example 8

An ink formulation containing a mixture of Silver Ink-3 and PEDOT-PSS doped with sorbitol (3 weight %) was prepared with a PEDOT-PSS:Ag ratio (parts by weight, dry weight) of 1:1. The Silver Ink-3 was diluted by mixing 1 part by weight of the Silver Ink-3 with 2 parts by weight of ethanol. The PEDOT-PSS was diluted by adding 1 part by weight of PEDOT-PSS and 6 parts by weight deionized water. Using the Test Device preparation method, source and drain electrodes were prepared by painting this ink formulation and baking at 125° C. for 10 minutes in air. Transistor performance of the test device thus made with these two electrodes was observed.

### Example 9

An ink formulation containing a mixture of Silver Ink-4 and PEDOT-PSS doped with sorbitol (3 weight %) was prepared with a PEDOT-PSS:Ag ratio (parts by weight, dry weight) of 1:1. No further dilution was needed for the silver ink-4 or PEDOT-PSS doped with sorbitol. Additionally 0.08 weight % of TMN-6 solution was added to aid wetting. The ink formulation was coated onto a glass slide using a No. 6 Mayer rod, and baked at a temperature of 100° C. in air for 7 minutes, followed by additional baking at 145° C. in a nitrogen environment for 30 minutes. The resulting film had a thickness of about 160 nanometers. The surface resistance was measured, and was in the range of 3-5×10³ ohms/square.

### Example 10

An ink formulation containing a mixture of Silver Ink-4 and PEDOT-PSS doped with sorbitol (3 weight %) was prepared with a PEDOT-PSS:Ag ratio (parts by weight, dry weight) of 1:2. Additionally, 0.08 weight % of TMN-6 solution was added to aid wetting. The ink formulation was coated onto a glass slide using a No. 6 Mayer rod and baked at a temperature of 100° C. in air for 7 minutes, followed by additional baking at 145° C. in a nitrogen environment for 30 minutes. The resulting film had a thickness of about 160 nanometers. The surface resistance was measured according to the test method above and was in the range of 3-5×10³ ohms/square.

### Example 11

Ink formulations of Comparative Example C1′ and Comparative Example C3′ were diluted as described in Example 2; Example 1 (additional centrifugation/decantation for removal of aggregated clusters); Example 2; Example 3; and Example 4 each contained 0.12 weight % of TMN-6 solution (wetting). These samples were coated onto a glass slide using a No. 6 Mayer rod, and baked at a temperature of 100° C. in air for 7 minutes, followed by additional baking at 150° C. in a nitrogen environment for 15 minutes. After annealing, the resulting film was washed with isopropanol to remove surfactant, and dried at about 125° C. in an oven for about 5 minutes. The average thickness and the surface resistance measured of the resulting films were measured, and used to calculate the average volume resistivity. The resistivity data is presented in Table 4. Higher average volume resistivity measurements for Example 1 may be the result of a lowered solids content due to aggregates removed from the dispersion (higher weight ratio of Ag nanoparticles). A higher average volume resistivity was measured for C1′ (Ag nanoparticles), and C3′ (sorbitol doped PEDOT/PSS) due to the lower solids content by dilution as compared to undiluted formulations of C1 and C3.

TABLE 4

| | Average Volume |
|---|---|
| | Resistivity |
| Example Ink | (ohm-cm) |
| C1′ | 9.30 × 10⁻⁵ |
| C3′ | 1.79 |
| 1 | 25.79 |
| 2 | 9.34 × 10⁻¹ |
| 3 | 6.96 × 10⁻¹ |
| 4 | 1.22 × 10⁻¹ |

1. An ink formulation comprising:
a) at least one conductive polymer;
b) metallic nanoparticles dispersed within the conductive polymer, wherein the weight ratio of the conductive polymer to the metallic nanoparticles ranges from 1:3 to 1:1; and
c) a carrier for mixing the conductive polymer and the metallic nanoparticles, the carrier being a solvent for the conductive polymer.

2. The ink formulation of claim 1, further comprising a dopant of at least one of sorbitol and glycerol.

3. The ink formulation of claim 1, wherein the conductive polymer is selected from the group consisting of poly(3,4-ethylenedioxythiophene)/poly(styrene sulfonate), polyaniline, polypyrrole, and combinations thereof

4. The ink formulation of claim 2, wherein the conductive polymer is poly(3,4-ethylenedioxythiophene)/poly(styrene sulfonate) and the dopant is sorbitol.

5. The ink formulation of claim 1, wherein the metallic nanoparticles are selected from the group consisting of silver, aluminum, copper, nickel and combinations thereof.

6. The ink formulation of claim 1, wherein the metallic nanoparticles have an average particle size less than about 500 nm.

7. The ink formulation of claim 1, wherein the metallic nanoparticles have an average particle size less than about 100 nm.

8-11. (canceled)

12. An organic electronic device comprising an electrode formed by an annealed ink formulation of claim 19.

13. The organic electronic device of claim 12, wherein the device comprises a transistor.

14. The transistor of claim 13 comprising at least one of a source and drain electrode.

15. The transistor of claim 13, wherein the annealed ink formulation further comprises a dopant selected from sorbitol and glycerol.

16. The transistor of claim 14, further comprising a semiconductor layer disposed on at least one of the source and drain electrodes.

17. The transistor of claim 16, wherein the semiconductor layer comprises 6,13-bis[(triisopropylsilanyl)ethynyl]pentacene.

18. An electronic device comprising a multiplicity of the transistors of claim 13.

19. A method for forming an electrode of an electronic device comprising the steps of applying the ink formulation of claim 1, and annealing.

20. The method of claim 19, wherein the step of applying includes ink jet printing, screen printing, gravure printing, flexographic printing, contact printing, or spraying.

21. The method of claim 19, wherein the annealing temperature ranges from 100° C. to 175° C.
